(19) United States
(12) Patent Application Publication
(10) Pub. No.: US 2009/0269537 A1
(43) Pub. Date: Oct. 29, 2009

(54) ADHESIVE SHEET AND DELIVERY SLIP

(75) Inventor: Norio MANABE, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 12/424,165

(22) Filed: Apr. 15, 2009

(30) Foreign Application Priority Data
Apr. 28, 2008 (JP) 2008-117420

(51) Int. Cl. G09F 3/10; B32B 7/12; G09F 3/02

(52) U.S. Cl. 428/43; 428/343

(57) ABSTRACT

One surface of a base sheet BS is provided with a delivery information display portion BS1 and a receipt information display portion BS2, and the other surface is laminated with a pseudo-adhesive layer 11, an intermediate member 12, and an adhesive layer 13 in order, where an antiadhesively treatment portion 14 is partially formed on the adhesive layer 13. The antiadhesively treatment portion 14 is provided for avoiding overall sticking with the adhesive layer 13, whereby an information sheet 15 can be placed in the area where the antiadhesively treatment portion 14 is provided so that the information sheet 15 is sandwiched between the antiadhesively treatment portion 14 and the adherend W. The receipt information display portion BS2 is detachably provided at the pseudo-adhesive layer 11 by forming of a cut-line C.

### BACKGROUND OF THE INVENTION

1. Field of the Invention

The present invention relates to an adhesive sheet and a delivery slip, particularly to an adhesive sheet being applicable to a delivery slip and a delivery slip thereof.

2. Related Art

Recently, with the universal spread of Internet shopping, TV shopping, and the like, mail-order sales have become popular in addition to traditional over-the-counter sales, and a distribution system by delivery companies to deliver products to consumers on behalf of sellers has been increasingly common. Consequently, leaks of information about the products such as the product name and price may be caused through the delivery slips. These information identify the products bought by the consumers, therefore such information are confidential information greatly concerning privacy of the consumers. Also from the perspective of discouraging theft during the course of distribution, they should be confidential information because the product value can be figured out from the product price.

The Patent Document 1 discloses a delivery slip. The delivery slip is provided with a delivery information fill-in portion on the front side, and is provided with a detachable see-through layer and an adhesive layer on the reverse side.

[Patent Document]

Japanese Patent Application Laid-Open No. 8-207470

### SUMMARY OF THE INVENTION

However, the delivery slip disclosed in the Patent Document 1 has a configuration in which an adhesive layer is provided simply on the whole area of the reverse surface of the delivery slip. Therefore it has a disadvantage that when an information sheet, which is written with confidential information and is sandwiched between the adhesive layer and an adherend, is intended to be taken out, the information sheet may be ripped and cannot be taken out smoothly since an adhesive agent is applied on the whole surface. And, there are other disadvantages, for example, when the delivery slip is peeled off, letters under the delivery slip can be seen by a delivery person and information intended to be secret may be leaked out. Further, print letters can be provided only on the front surface of the delivery slip, that means, there is only the delivery information fill-in portion and no other area allowing other information to be entered.

The present invention has been made in view of the above disadvantages, and an object is to provide an adhesive sheet, for example, when the invention is applied to a delivery slip and the like, an information sheet written with confidential information can be sandwiched between the adhesive sheet and an adherend, and the information sheet can be taken out smoothly.

Additionally, another object of the present invention is to provide an adhesive sheet and a delivery slip, for example, when the invention is applied to a delivery slip in which a part is detachably provided, an adherend surface side can be concealed, or the adherend surface side cannot be read when the part is peeled off.

A further object of the present invention is to provide an adhesive sheet and a delivery slip capable of indicating more information.

In order to achieve the above objects, the present invention adopts such an arrangement that an adhesive sheet includes: a base sheet with one surface arranged as a printing surface and the other surface laminated with a pseudo-adhesive layer and an adhesive layer in order, wherein an antiadhesively treatment portion is partially formed on the adhesive layer.

According to the present invention, the antiadhesively treatment portion may be colored, and the antiadhesively treatment portion may maintain an adherend surface side unreadable when the base sheet is peeled at the pseudo-adhesive layer.

And, such an arrangement may be adopted that a cut-line is formed with a depth beyond a pseudo-adhesive surface from the base sheet side in order to allow the base sheet to be partially peeled off, and a street without the antiadhesively treatment portion is provided on the adhesive layer under the cut-line.

Also, the antiadhesively treatment portion maybe formed with printing mirror letters which may be provided visibly through the adhesive layer when the base sheet is peeled at the pseudo-adhesive layer.

Further, such an arrangement may be adopted that an information sheet capable of interposing between the adhesive layer and the adherend surface through the antiadhesively treatment portion, wherein the information sheet is printed with confidential information.

Furthermore, the base sheet may include at least a delivery information display portion and a receipt information display portion, wherein a portion in the base sheet corresponding to the receipt information display portion functions as a delivery slip being detachable at the pseudo-adhesive surface in the pseudo-adhesive layer.

Still further, the present invention adopts such an arrangement that a delivery sheet includes: an adhesive sheet having a base sheet with one surface arranged as a printing surface and the other surface laminated with a pseudo-adhesive layer and an adhesive layer in order; and an information sheet capable of interposing between the adhesive sheet and an adherend surface, wherein a antiadhesively treatment portion is partially formed on the adhesive layer, and the information sheet is provided to be capable of interposing through the antiadhesively treatment portion.

The pseudo-adhesive layer in the present invention may be arranged with a plurality of films, for example, a two-layered laminated film, and they may be detachably provided at their interface, that is, a pseudo-adhesive surface. Examples of the films to be used for the pseudo-adhesive forming layers include a polyethylene resin, a polystyrene resin, an acrylic resin, a natural rubber-base resin, a vinyl chloride-vinyl acetate copolymer, an ethylene-vinyl acetate copolymer, a UV-curable varnish, and a polyethylene terephthalate resin. A laminated film composed of their optional combination may be used as the pseudo-adhesive layer.

In this specification, a term “print letters” is used as a concept including characters, symbols, graphics, or their optional combinations; and a term “transparent” is a concept including translucence.

According to the present invention, since the adhesive layer is partially provided with the antiadhesively treatment portion, it becomes partial attachment without attaching whole surface of the adhesive layer onto the adherend surface. Therefore, when the adhesive sheet is applied to a delivery slip, the delivery slip becomes easy to be peeled off from a delivery package. And, when the information sheet is sandwiched between the adhesive layer and the adherend surface through the antiadhesively treatment portion, the information sheet can be taken out smoothly without ripping.

Also, according to an arrangement in which the antiadhesively treatment portion is colored so that the adherend surface side is unreadable, the adherend surface can be concealed and a concealing property of the information sheet right after peeling at the pseudo-adhesive surface can be securely maintained.

Further, according to an arrangement in which the street is provided under the cut-line formed in the base sheet, the cut-line is not affected by differences in thickness caused by the antiadhesively treatment portion in a process of forming the cut-line, and can be prevented from reaching up to a layer where cut-line is needless, whereby the base sheet can be peeled off unfailingly at the pseudo-adhesive surface. Moreover, a possible occurrence of adhesion failure of the adhesive sheet can be avoided owing to presence of the street.

Still further, when the antiadhesively treatment portions have an indicating function, particularly, when they were formed by mirror letters, they can be seen when a part of the base sheet is peeled off, and, for example, by forming the antiadhesively treatment portions with logos and textual information, functions such as advertisement and promotion can be additionally provided.

### BRIEF DESCRIPTION OF THE DRAWINGS

FIG. 1 is a perspective view schematically showing an embodiment in which an adhesive sheet according to the present invention is applied to a delivery slip.

FIG. 2 is an exploded side view showing a layered structure of the adhesive sheet.

FIG. 3 is a perspective view schematically showing a peeling state of a receipt information display portion which is a part of a base sheet.

FIG. 4 is a perspective view schematically showing a taking out state of an information sheet.

### DETAILED DESCRIPTION OF THE PREFERRED EMBODIMENT

Hereinafter, an exemplary embodiment of the present invention will be described with reference to the accompanying drawings.

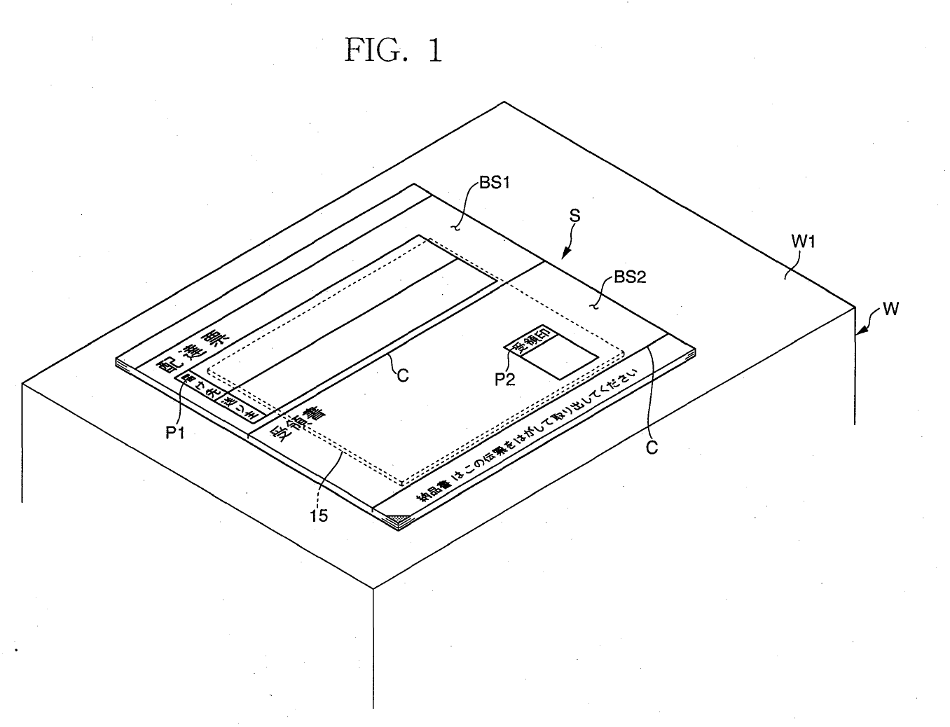

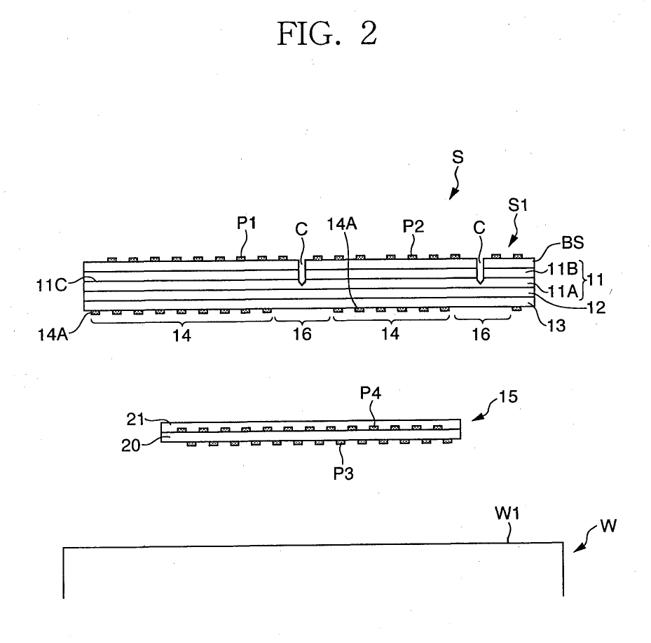

FIG. 1 shows a schematic perspective view of an embodiment of a delivery slip of a product via home-delivery and the like to which an adhesive sheet S according to the present invention is applied, and FIG. 2 shows an exploded side view thereof. In these drawings, the adhesive sheet S is used by attaching onto an adherend W which is a package of a product via home-delivery and the like. The adhesive sheet S generally has a substantially square plane shape, and the adhesive sheet S includes an adhesive sheet body Si provided with a base sheet BS, a pseudo-adhesive layer 11, an intermediate member 12, an adhesive layer 13, and a antiadhesively treatment portion 14 which is partially formed on the adhesive layer 13; and an information sheet 15 which is interposed between the adhesive layer 13 and an adherend surface W1 through the antiadhesively treatment portion 14.

The base sheet BS composed of an opaque sheet material, in which one surface, that is, the upper surface in FIG. 2 is arranged as a printing surface, and the other surface is arranged as a lamination plane with the pseudo-adhesive layer 11 and the adhesive layer 13. The base sheet BS includes a delivery information display portion BS1 and a receipt information display portion BS2; in which the receipt information display portion BS2 is formed with a pair of cut-lines C which have a depth beyond a pseudo-adhesive surface 11C from the base sheet BS side, thereby allowing the receipt information display portion BS2 which is a part of the base sheet BS to be partially peeled off at the pseudo-adhesive surface 11C. The upper surface of the delivery information display portion BS1 is provided with print letters P1 regarding destination and the like of the adherend W, which is a product to be delivered; and the upper surface of the receipt information display portion BS2 is provided with print letters P2 including various information regarding reception such as a column for a receipt stamp by a recipient. In this regard, a description is provided in an area of the base sheet BS except the receipt information display portion BS2 to clearly indicate that the information sheet 15 including a guarantee form, an invoice form, and the like, is inserted therebehind.

As shown in FIG. 2, the pseudo-adhesive layer 11 is laminated with upper and lower layers, and at least lower layers are composed of transparent layers, and in the embodiment, the pseudo-adhesive layer 11 is arranged with, though is not particularly limited to, a first film layer 11A made of polystyrene, and a second film layer 11B made of low-density polyethylene being located on the upper surface side of the first film layer 11A; in which the interface between the first and second film layers 11A and 11B is arranged to be detachable as the pseudo-adhesive surface 11C.

The intermediate member 12 is composed of, though is not particularly limited to, glassine paper, and the adherend surface W1 side can be seen through the adhesive layer 13.

An adhesive agent to be used for the adhesive layer 13 has a sufficient strength for securely holding the information sheet in a state that the adhesive sheet body S1 is attached onto the adherend W when performing peeling at the pseudo-adhesive surface 11C.

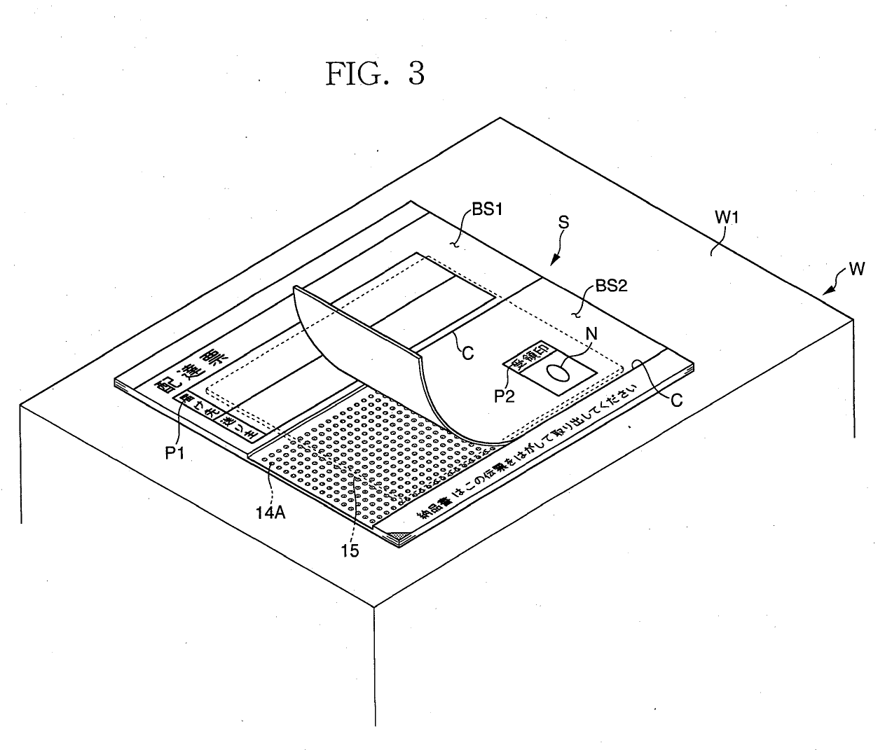

As shown in FIG. 2 and FIG. 3, the antiadhesively treatment portion 14 is composed of a laminate with a large number of colored dots 14A, which are formed by printing, by attaching a film, or the like. Since the antiadhesively treatment portion 14 is partially formed on the adhesive layer 13, the adhesive sheet body S1 is attached onto the adherend W by the adhesive layer 13 which is exposed partially or at intervals among the dots 14A. Accordingly, overall sticking with the adhesive layer 13 onto the adherend W can be avoided, whereby it becomes partial attachment. Also, since the antiadhesively treatment portion 14 is not provided under the cut-lines C, a pair of streets 16 are formed along the cut-lines C. The streets 16 are configured to prevent the cut-lines C from reaching the intermediate member 12 or the adhesive layer affected by differences in thickness caused by the dots 14A in a process of forming the cut-lines C, so that the receipt information display portion BS2 can be peeled off unfailingly at the pseudo-adhesive surface.

The information sheet 15 includes a base member 20 capable of being printed, and a release treatment layer 21 laminated on the upper surface of the base member 20. The under surface side of the base member 20 is provided with print letters P3 of confidential information such as an invoice including product name, price, and the like, while the upper surface side is provided with print letters P4 of formulaic letters such as a guarantee form and articles of cooling-off concerning a delivery product. In this regard, the guarantee form, articles of cooling-off, and the like may indirectly identify the product to be delivered, therefore, they also could be confidential information.

Next, usage of the adhesive sheet S in accordance with the embodiment will be described.

The delivery information display portion BS1 in the base sheet BS is provided with the print letters P1 regarding destination and the like of a product to be delivered, while the receipt information display portion BS2 is provided with the print letters P2 regarding reception of the delivered product. And, the base member 20 in the information sheet 15 is provided with the print letters P3 regarding confidential information. Since the print letters P4 are formulaic letters, they have been printed before the release treatment layer 21 is laminated.

In the above condition, the information sheet 15 is sandwiched between the adhesive sheet body S1 and the adherend W to be attached onto the adherend through the exposed adhesive layer 13. Consequently, the adhesive sheet S is to be attached onto the adherend W through the portion other than the dots 14A portion which forms the antiadhesively treatment portion 14, and the streets 16, whereby the information sheet 15 is maintained in a state of being unable to be taken out as long as the adhesive sheet body Si is not peeled off.

When a product via home-delivery attached with the adhesive sheet S is delivered to a recipient, as shown in FIG. 3, a delivery person receives a stamp N as the signet of the recipient on the column for the receipt stamp in the receipt information display portion BS2, and then peels off the receipt information display portion BS2 to bring it back. The peeling-off is performed at the pseudo-adhesive surface 11C described above. In this regard, the adherend surface side can be seen through by peeling off the receipt information display portion BS2. However, since the antiadhesively treatment portion 14 is formed there, the letters are only partially seen among each of the dots 14A, and they are illegible. That means, the letters are maintained in substantially unreadable. Therefore, the delivery person cannot see through the print letters P4 provided on the information sheet 15.

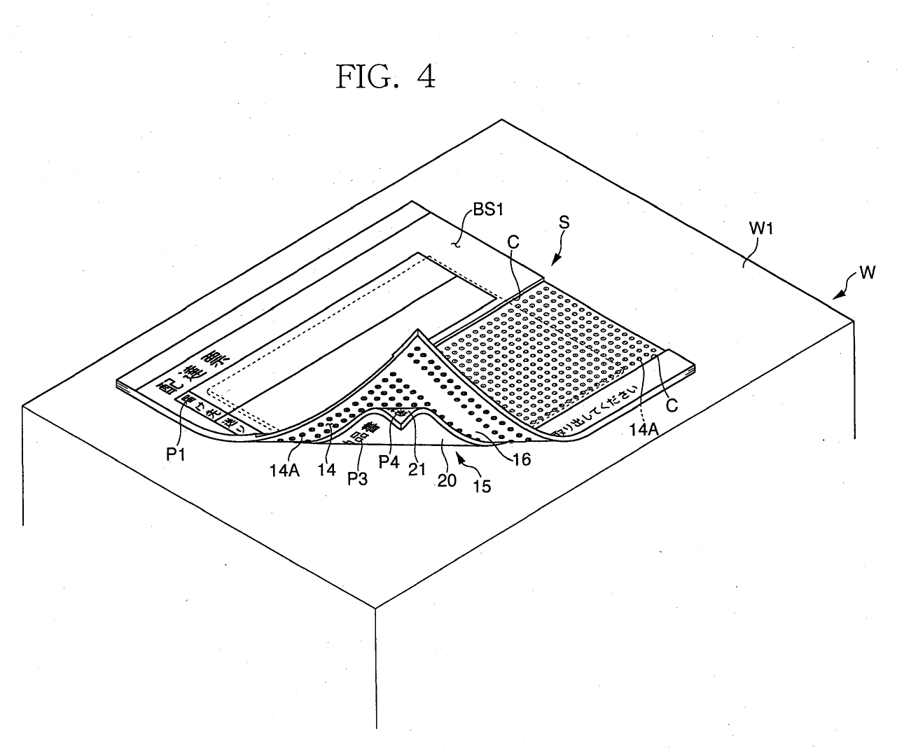

As shown in FIG. 4, the recipient may pick an edge portion of the adhesive sheet body S1 and peel it off from the adherend W, and then the recipient may pick the information sheet 15 which is attached to the adhesive layer 13 side and take it out. In this regard, the adhesive layer 13 is in only partial attachment owing to the antiadhesively treatment portion 14, disadvantages such as ripping of the information sheet 15 may be prevented. In the information sheet 15 of the embodiment, the peeling treatment layer 21 side thereof is attached to the adhesive layer 13 side, the information sheet 15 can be taken out more smoothly.

Therefore, according to the embodiment as described above, the adhesive sheet S can be attached onto the adherend W in a state that the information sheet 15 is inserted in the under surface side of the adhesive sheet S, and a concealing property can be securely maintained owing to presence of the antiadhesively treatment portion 14 even when the receipt information display portion BS2 is peeled off.

Since the antiadhesively treatment portion 14 is configured by providing a large number of dot-shaped prints and the like, for example, it can have roles as advertising and promoting functions by printing logos, textual information, and the like, for indicating a manufacturer of the delivery product.

The best arrangement, method and the like for carrying out the present invention have been disclosed so far. However, the present invention is not limited to the above.

That is, the present invention has been illustrated and described mainly about a specific embodiment. However, it is possible for those skilled in the art to add various modifications, if necessary, to the above-described embodiment with respect to the shape, position and/or disposition without departing from the technical spirit and the range of the object of the present invention.

For example, other information display portion may be provided on the base sheet BS in addition to the delivery information display portion BS1 and the receipt information display portion BS2.

And, the antiadhesively treatment portion 14 can be printed with logos, campaign information, drawing patterns, characters, and the like, for featuring the service providing company of the delivery product and the like by mirror letters provided or printed from the adhesive layer 13 side, in addition to the dots 14A.

Also, number of layers in the adhesive sheet S according to the present invention is not limited to the illustrated arrangement example, and the layers may be increased or decreased as necessary, as long as they have similar effects to the above.

Further, the adhesive sheet S may be applied, not limited to an delivery slip of the product via home-delivery, but also to other labels and the like, in which confidential information is required to be concealed without leaking out, and optionally, various changes such as the planar shape of the adhesive sheet S may be made.

Furthermore, the antiadhesively treatment portion 14 may be formed by using an energy beam such as an ultraviolet ray, in addition to by printing, by attaching a film, and the like, to partially eliminate its adhesive property.

Still further, the cut-line C is not limited to a straight line, and the street 16 may be conformed according to the shape of the cut-line C.

What is claimed is:

1. An adhesive sheet, comprising: a base sheet with one surface arranged as a printing surface and the other surface laminated with a pseudo-adhesive layer and an adhesive layer in order, wherein an antiadhesively treatment portion is partially formed on the adhesive layer.

2. The adhesive sheet according to claim 1, wherein the antiadhesively treatment portion is colored, and the antiadhesively treatment portion maintains an adherend surface side unreadable when the base sheet is peeled at the pseudo-adhesive layer.

3. The adhesive sheet according to claim 1, wherein a cut-line is formed with a depth beyond a pseudo-adhesive surface from the base sheet side in order to allow the base sheet to be partially peeled off, and a street without the antiadhesively treatment portion is provided in the adhesive layer under the cut-line.

4. The adhesive sheet according to claim 1, wherein the antiadhesively treatment portion is formed with printing mirror letters which are provided visibly through the adhesive layer.

5. The adhesive sheet according to claim 1, further comprising: an information sheet capable of interposing between the adhesive layer and the adherend surface through the antiadhesively treatment portion, wherein the information sheet is printed with confidential information.

6. The adhesive sheet according to claim 1, wherein the base sheet comprises at lease a delivery information display portion and a receipt information display portion, and a portion in the base sheet corresponding to the receipt information display portion functions as a delivery slip being detachable at the pseudo-adhesive surface in the pseudo-adhesive layer.

7. A delivery sheet, comprising: an adhesive sheet having a base sheet with one surface arranged as a printing surface and the other surface laminated with a pseudo-adhesive layer and an adhesive layer in order; and an information sheet capable of interposing between the adhesive sheet and an adherend surface, wherein
an antiadhesively treatment portion is partially formed on the adhesive layer, and the information sheet is provided to be capable of interposing through the antiadhesively treatment portion.
